(19) United States
(12) Patent Application Publication
(10) Pub. No.: US 2006/0136886 A1
(43) Pub. Date: Jun. 22, 2006

(54) Process and implementation for interrupting locked threads

(76) Inventors: Bret Patterson, Cedar Park, TX (US); John Richards Rowland, Coupland, TX (US); Kirk Malcolm Sexton, Austin, TX (US)

Correspondence Address: IBM CORP (YA);C/O YEE & ASSOCIATES PC, P.O. BOX 802333, DALLAS, TX, 75380, US

(21) Appl. No.: 11/014,056

(22) Filed: Dec. 16, 2004

(51) Int. Cl. G06F 9/45

(52) U.S. Cl. 717/141

(57) ABSTRACT

A thread monitor identifies and interrupts locked threads. A byte code insertion tool inserts timers around classes that are bound to threads. Timers may also be inserted around particular portions of code. When a portion of code, such as a thread, a loop, or a condition block, for example, to be monitored begins, a call is made to a thread monitor to start a timer. If the portion of code ends normally, the timer is removed. If the timer expires, then the thread monitor may interrupt the thread or send a notification to a user so that appropriate action may be taken.

### BACKGROUND OF THE INVENTION

1. Technical Field

The present invention relates to data processing and, in particular, to managing thread resources in a data processing system. Still more particularly, the present invention provides a method, apparatus, and program product for using byte code insertion for interrupting locked threads.

2. Description of Related Art

Multi-threaded applications face several problems. For instance, deadlock is a state where threads compete for resources and wait for each other in a permanent state of stalemate. As a specific example, a first thread may attempt to perform a transaction between resources r1, r2 and a second thread may attempt to perform a transaction between r2, r1. The first thread may acquire a lock on resource r1 while the second thread acquires a lock on resource r2. Thus, each thread waits for the other to release the needed resource.

Another problem facing multi-threaded applications is a race condition. A software race condition occurs when the execution of a program is affected by the order and timing of a thread's execution. When a deadlock or race condition, for example, occurs a thread may become “locked.” In other words, a thread may be in a state of execution for a longer period of time than expected and may remain in that state until interrupted.

However, when a thread is in a race condition or “locked” condition, this state may go unnoticed until a human observer discovers the problem. An administrator may then manually interrupt the thread and restart the application. However, a considerable amount of processing time may be lost in the meantime, which may result in a cost for the customer running the application.

This may also damage the customer's perception of the service provider and may directly result in a loss of income by the service provider. For example, an owner of the server may allow customers to run applications on the server in an e-business data processing environment. The server owner may provide this service to the customer under a service level agreement. Thus, if an application thread gets locked and is not immediately interrupted, the application may not be able to execute an agreed-upon number of transactions and, thus, may not satisfy the service level agreement.

### SUMMARY OF THE INVENTION

The present invention recognizes the disadvantages of the prior art and provides a thread monitor that identifies and interrupts locked threads. A byte code insertion tool is used to insert timers around classes that are bound to threads. Timers may also be inserted around particular portions of code. When a portion of code, such as a thread, a loop, or a condition block, for example, to be monitored begins, a call is made to a thread monitor to start a timer. If the portion of code ends normally, the timer is removed. If the timer expires, then the thread monitor may interrupt the thread or send a notification to a user so that appropriate action may be taken.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram of a data processing system in which exemplary aspects of the present invention may be implemented;

FIG. 4 is a diagram illustrating a software configuration for byte code insertion for interrupting locked threads in accordance with an exemplary embodiment of the present invention;

FIG. 5 illustrates an example operation of a thread monitor in accordance with a preferred embodiment of the present invention;

FIG. 6 is a flowchart illustrating creation and execution of an application thread in accordance with an exemplary embodiment of the present invention; and

FIG. 7 is a flowchart illustrating the operation of a thread monitor in accordance with an exemplary embodiment of the present invention.

### DETAILED DESCRIPTION OF THE PREFERRED EMBODIMENT

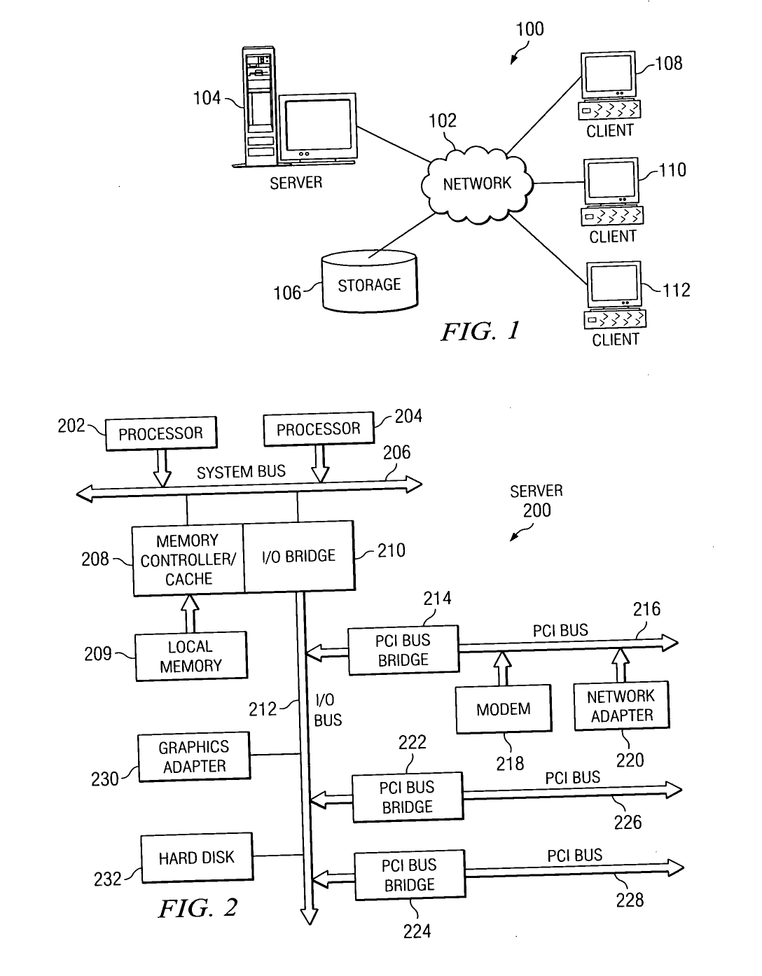

The present invention provides a method, apparatus and computer program product for monitoring threads and interrupting locked threads. The data processing device may be a single-processor computing device, a multiprocessing data processing system, or a virtual processor environment in which multiple processors and multiple layers of software may be utilized to perform various aspects of the present invention. Therefore, the following FIGS. 1-3 are provided as exemplary diagrams of data processing environments in which the present invention may be implemented. It should be appreciated that FIGS. 1-3 are only exemplary and are not intended to assert or imply any limitation with regard to the environments in which the present invention may be implemented. Many modifications to the depicted environments may be made without departing from the spirit and scope of the present invention.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. More particularly, server 104 may run applications for customers. These applications may provide products or services for end users at clients 108, 110, and 112, which are clients to server 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessing (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer™ pseries® system, a product of International Business Machines Corporation in Armonk, N.Y., running the Advanced Interactive Executive (AIX™) operating system or LINUX operating system.

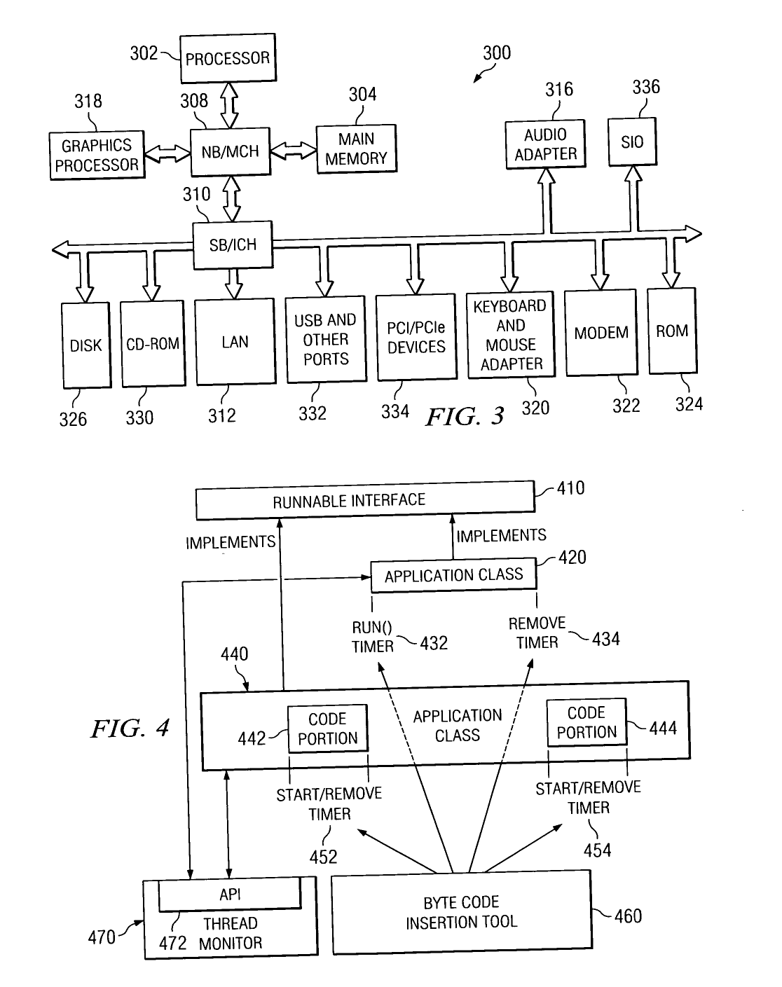

With reference now to FIG. 3, a block diagram of a data processing system is shown in which exemplary aspects of the present invention may be implemented. Data processing system 300 is an example of a computer, such as client 108 in FIG. 1, in which code or instructions implementing the processes of the present invention may be located. In the depicted example, data processing system 300 employs a hub architecture including a north bridge and memory controller hub (MCH) 308 and a south bridge and input/output (I/O) controller hub (ICH) 310. Processor 302, main memory 304, and graphics processor 318 are connected to MCH 308. Graphics processor 318 may be connected to the MCH through an accelerated graphics port (AGP), for example.

In the depicted example, local area network (LAN) adapter 312, audio adapter 316, keyboard and mouse adapter 320, modem 322, read only memory (ROM) 324, hard disk drive (HDD) 326, CD-ROM driver 330, universal serial bus (USB) ports and other communications ports 332, and PCI/PCIe devices 334 may be connected to ICH 310. PCI/PCIe devices may include, for example, Ethernet adapters, add-in cards, PC cards for notebook computers, etc. PCI uses a cardbus controller, while PCIe does not. ROM 324 may be, for example, a flash binary input/output system (BIOS). Hard disk drive 326 and CD-ROM drive 330 may use, for example, an integrated drive electronics (IDE) or serial advanced technology attachment (SATA) interface. A super I/O (SIO) device 336 may be connected to ICH 310.

An operating system runs on processor 302 and is used to coordinate and provide control of various components within data processing system 300 in FIG. 3. The operating system may be a commercially available operating system such as Windows XP™, which is available from Microsoft Corporation. An object oriented programming system, such as the Java™ programming system, may run in conjunction with the operating system and provides calls to the operating system from Java™ programs or applications executing on data processing system 300. “JAVA” is a trademark of Sun Microsystems, Inc.

Instructions for the operating system, the object-oriented programming system, and applications or programs are located on storage devices, such as hard disk drive 326, and may be loaded into main memory 304 for execution by processor 302. The processes of the present invention are performed by processor 302 using computer implemented instructions, which may be located in a memory such as, for example, main memory 304, memory 324, or in one or more peripheral devices 326 and 330.

Those of ordinary skill in the art will appreciate that the hardware in FIG. 3 may vary depending on the implementation. Other internal hardware or peripheral devices, such as flash memory, equivalent non-volatile memory, or optical disk drives and the like, may be used in addition to or in place of the hardware depicted in FIG. 3. Also, the processes of the present invention may be applied to a multiprocessor data processing system.

For example, data processing system 300 may be a personal digital assistant (PDA), which is configured with flash memory to provide non-volatile memory for storing operating system files and/or user-generated data. The depicted example in FIG. 3 and above-described examples are not meant to imply architectural limitations. For example, data processing system 300 also may be a tablet computer, laptop computer, or telephone device in addition to taking the form of a PDA.

Returning to FIG. 1, server 104 may run applications for customers. These applications may be provided as part of an electronic business services platform, for example. End users at clients 108, 100, 112 may be performing transactions using applications on server 104. Applications running on server 104 may be crucial to the business practices of a customer. Thus, having a locked thread in an application could be costly to the customer and may be detrimental to relationship with the electronic business services provider and the customer.

In accordance with a preferred embodiment of the present invention, a thread monitor is provided that identifies and interrupts locked threads. A byte code insertion tool is used to insert timers around application classes that are bound to threads. Timers may also be inserted around particular portions of code. When a portion of code, such as a thread, a loop, or a condition block, for example, to be monitored begins, a call is made to a thread monitor to start a timer. If the portion of code ends normally, the timer is removed. If the timer expires, then the thread monitor may interrupt the thread or send a notification to a user so that appropriate action may be taken.

FIG. 4 is a diagram illustrating a software configuration for byte code insertion for interrupting locked threads in accordance with an exemplary embodiment of the present invention. In one exemplary embodiment of the present invention, application class 420 and application class 440 implement Runnable interface 410. An interface is a class that defines the structure of another class. In other words, an interface defines the methods that a class may have.

Runnable interface 410 is part of the Java 2 Standard Edition (J2SE) development kit from Sun Microsystems. J2SE is a software development kit for building mission critical enterprise applications. Any class whose instances are intended to be executed by a thread may implement Runnable interface 410. The class must define a method of no arguments called run ( ). Therefore, since application class 420 in particular implements Runnable interface 410, application class 420 includes code for a run ( ) method.

When an instance of application class 420 is bound to a thread, starting the thread causes the run ( ) method to execute. In an exemplary embodiment of the present invention, byte code insertion tool 460 modifies the run ( ) method to communicate with thread monitor 470 through application programming interface (API) 472. Byte code insertion tool 460 examines the class definition to determine if the class includes any code that might lock the thread. For example, if the methods of application class 420 include any loops, functional invocations, or control structures or conditional blocks, then byte code insertion tool 460 prepends bytes into the code. More specifically, byte code insertion tool 460 may modify the run ( ) method to include instructions 432 to notify thread monitor 470 to start a timer and to include instructions 434 to remove the timer if the thread ends execution before the timer expires.

Alternatively, as illustrated in FIG. 4, byte code insertion tool 460 may examine the methods of application class 440 to identify particular cod portions 442, 444 that might possibly lock the thread. In this example, byte cod insertion tool 460 may insert bytes into the code to include a timer around each code portion. In the depicted example, byte code insertion tool 460 inserts start/remove timer instructions 452 around code portion 442 and inserts start/remove instructions 454 around code portion 444.

At injection time, when an instance of a class is bound to a thread and before the thread is started, byte code insertion tool 460 examines the methods of a class to determine whether timers are to be inserted. This determination may be made using profiles. For example, a class with numerous loops and control structures may require separate, shorter timers for each code portion. On the other hand, a class with function invocations may require a single, longer timer inserted into the run ( ) method, for example. As a further example, a default profile may call for the insertion of a single ten second timer into the run ( ) method. The manner in which byte code insertion tool 460 inserts the timer instructions into application classes

When a thread is started and the inserted instructions indicating that a timer is to be started are encountered, the instructions notify thread monitor 470 to start a timer through API 472. This notification may be made through a procedure call that identifies the thread and the length of time for the timer. Thread monitor 470 starts the timer and associates the timer with the thread. When a timer expires, thread monitor 470 may either interrupt the thread or send notification to a user so that the user may take appropriate action.

Byte code insertion tool 460 may be a component of a virtual machine or runtime environment. In an alternative embodiment, byte code insertion tool 460 may be a helper application that is executed within the runtime environment to analyze classes and insert byte code to modify a class.

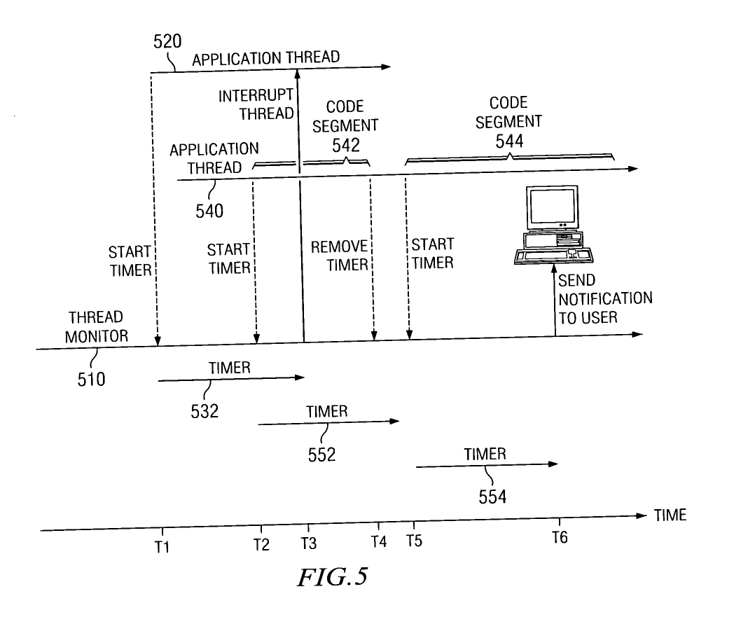

FIG. 5 illustrates an example operation of a thread monitor in accordance with a preferred embodiment of the present invention. Thread monitor 510 monitors application threads for locked conditions. In the depicted example, application thread 520 implements the Runnable interface and, thus, includes the run ( ) method. Using byte code insertion, the run ( ) method is modified to start a timer when the thread begins execution and to remove the timer when the thread terminates. Application thread 540 includes code segment 542 and code segment 544 that are identified as potentially causing a locked condition. Using a byte code insertion tool, byte code instructions are inserted before and after code segments 542, 544 to start and remove timers around the code segments.

As illustrated in FIG. 5, at time T1 application thread 520 instructs thread monitor 510 to start timer 532 when the thread begins execution. Application thread 520 may also include a timer value for timer 532. If a timer value is not specified, thread monitor 510 may use a default value, such as ten seconds, for example.

Thread monitor 510 associates timer 532 with application thread 520. Application thread 540 begins execution and, at time T2, encounters code segment 542. At this time, application thread 540 instructs thread monitor 510 to start timer 552. Thread monitor 510 associates timer 552 with application thread 540.

Next, at time T3, timer 532 expires. Thread monitor 510 then determines that application thread 520 may be locked and takes appropriate action. The action to be taken may be determined using a profile. For example, thread monitor 510 may have other information about application thread 520 and may determine based on this information that application thread 520 should be interrupted. Alternatively, thread monitor 510 may send notification to a user so that the user may take appropriate action. In the depicted example, thread monitor 510 interrupts application thread 520 at time T3.

At time T4, code segment 542 completes and application thread 540 encounters an instruction to remove timer 552. Application thread 540 then instructs thread monitor 510 to remove timer 552 using the API of thread monitor 510. Thread monitor 510 then removes timer 552.

At time T5, application thread 540 encounters code segment 544. At this time, application thread 540 instructs thread monitor 510 to start timer 554. Thread monitor 510 associates timer 554 with application thread 540. Then, at time T6, timer 554 expires and thread monitor 510 sends notification to a user so that the user may take appropriate action.

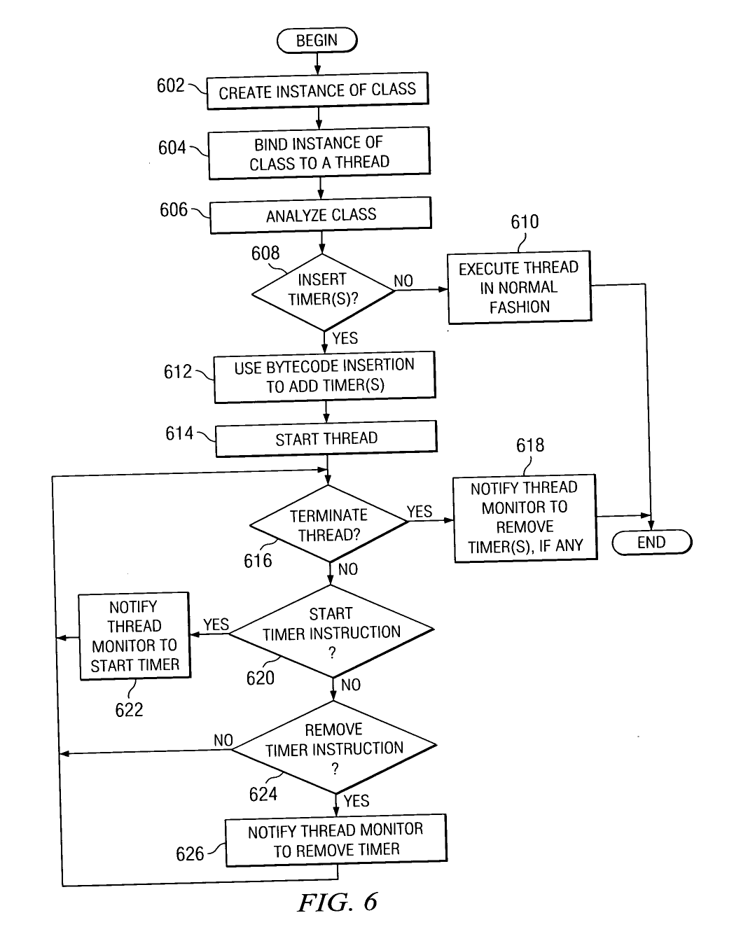

FIG. 6 is a flowchart illustrating creation and execution of an application thread in accordance with an exemplary embodiment of the present invention. Operation begins and an instance of the application class is created (block 602). Then, the runtime environment binds the instance of the class to a thread (block 604). The byte code insertion tool analyzes the class (block 606) and a determination is made as to whether one or more timers are to be inserted into the code of the class (block 608).

As described above, the byte code insertion tool may use profiles to determine whether timers are to be inserted. For example, the byte code insertion tool may determine whether the class includes function invocations, loops, control structures, or the like. An example profile may dictate that particular code segments may be “wrapped” with timers. On the other hand, another example profile may dictate that threads with function invocations may have a timer inserted into the run ( ) method, for example. If the byte code insertion tool determines that timers are not to be inserted into the class, the thread executes in a normal fashion (block 610) and operation ends.

If the byte code insertion tool determines that timers are to be inserted into the code of the class in block 608, the byte code insertion tool inserts add/remove timer instruction into the class (block 612). A determination is made as to whether execution of the thread terminates (block 616). If execution of the thread terminates, the application thread notifies the thread monitor to remove any timers associated with that thread (block 618) and operation ends. Notification may be made by making a call to the API of the thread monitor, for example.

If execution of the thread does not terminate in block 616, a determination is made as to whether a start timer instruction is encountered (block 620). If a start timer instruction is encountered, the application thread notifies the thread monitor to start a timer (block 622). This notification may also include a timer value. Thereafter, operation returns to block 616 to determine whether execution of the thread terminates.

If a start timer instruction is not encountered in block 620, a determination is made as to whether a remove timer instruction is encountered (block 624). If a remove timer instruction is encountered, the application thread notifies the thread monitor to remove the timer (block 626). Thereafter, operation returns to block 616 to determine whether execution of the thread terminates. At any point during the execution of the application thread, the thread monitor or a user may interrupt execution of the thread. The application thread itself does not perform any express operations to interrupt execution. The application thread assumes that execution will terminate in a normal fashion.

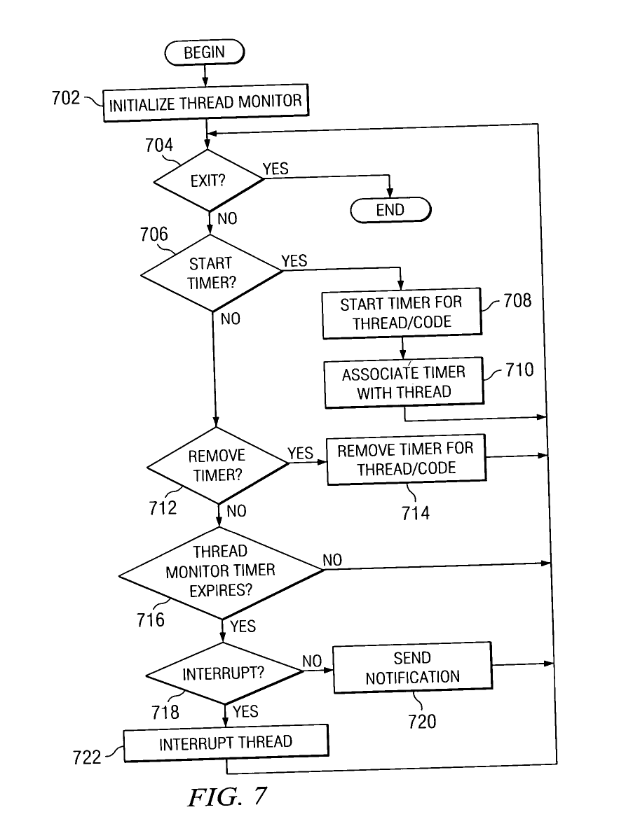

FIG. 7 is a flowchart illustrating the operation of a thread monitor in accordance with an exemplary embodiment of the present invention. Operation begins and the thread monitor is initialized (block 702). A determination is made as to whether an exit condition exists (block 704). An exit condition may exist when the runtime environment is terminated, such as when the data processing system shuts down, for example. If an exit condition exists, operation ends.

If an exit condition does not exist in block 704, a determination is made as to whether a start timer notification is received from an application thread (block 706). If a start timer notification is received, the thread monitor starts a timer (block 708) and associates the timer with the application thread (block 710). Thereafter, operation returns to block 704 to determine whether an exit condition exists.

If a start timer notification is not received in block 706, a determination is made as to whether a remove timer notification is received from an application thread (block 712). If a remove timer notification is received from an application thread, then the corresponding portion of code completed execution without locking. The thread monitor removes the timer for the thread or portion of code (block 714). Thereafter, operation returns to block 704 to determine whether an exit condition exists.

If a remove timer notification is not received in block 712, a determination is made as to whether a thread monitor timer expires (block 716). If a thread monitor timer does not expire, operation returns to block 704 to determine whether an exit condition exists. If, however, a timer does expire in block 716, then the thread monitor assumes that the thread is in a locked condition. A determination is made as to whether to interrupt the thread (block 718).

If the thread monitor decides not to interrupt the thread, the thread monitor sends notification to a user so that the user may take the appropriate action (block 720). Thereafter, operation returns to block 704 to determine whether an exit condition exists. If the thread monitor decides to interrupt the thread in block 718, the thread monitor interrupts the thread (block 722) and operation returns to block 704 to determine whether an exit condition exists.

Thus, the present invention solves the disadvantages of the prior art by providing a thread monitor that identifies and interrupts locked threads. A byte code insertion tool is used to insert timers around classes that are bound to threads. Timers may also be inserted around particular portions of code. When a portion of code, such as a thread, a loop, or a condition block, for example, to be monitored begins, a call is made to a thread monitor to start a timer. If the portion of code ends normally, the timer is removed. If the timer expires, then the thread monitor may interrupt the thread or send a notification to a user so that appropriate action may be taken.

In the above description, byte code insertion is used to insert timers in an application class to be monitored. However, other techniques to instrument or hook code on the fly may be used to add timers to classes that are to be monitored.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for managing an application thread, the method comprising:
analyzing a portion of code bound to an application thread to identify candidate code that is a candidate to result in a locked condition;
inserting first instructions to start a timer and second instructions to remove the timer around the candidate code;
executing the first instructions to notify a thread monitor to start the timer; and
if the candidate code completes execution without locking, executing the second instructions to notify the thread monitor to remove the timer.

2. The method of claim 1, wherein inserting first instructions to start a timer and second instructions to remove the timer include using byte code insertion to insert the first instructions and second instructions into the portion of code.

3. The method of claim 1, wherein the portion of code is an application class, wherein the first instructions start the timer when the thread begins execution, and wherein the second instructions remove the timer when the thread completes execution.

4. The method of claim 1, further comprising:
responsive to receiving notification of an expired timer from the thread monitor, interrupting the application thread.

5. A method, in a data processing system, for monitoring threads, the method comprising:
receiving, from an application thread, notification to start a timer;
associating the timer with the application thread;
responsive to expiration of the timer, taking an action.

6. The method of claim 5, wherein the action includes interrupting the application thread.

7. The method of claim 5, wherein the action includes notifying a user that a locked condition exists for the application thread.

8. The method of claim 5, further comprising:
responsive to receiving, from the application thread, notification to remove the timer, removing the timer.

9. A computer program product, in a computer readable medium, for managing an application thread, the computer program product comprising:
instructions for analyzing a portion of code bound to an application thread to identify candidate code that is a candidate to result in a locked condition;
instructions for inserting first instructions to start a timer and second instructions to remove the timer around the candidate code;
instructions for executing the first instructions to notify a thread monitor to start the timer; and
instructions for executing the second instructions to notify the thread monitor to remove the timer if the candidate code completes execution without locking.

10. The computer program product of claim 9, wherein the portion of code is an application class, wherein the first instructions start the timer when the thread begins execution, and wherein the second instructions remove the timer when the thread completes execution.

11. The computer program product of claim 9, further comprising:
instructions for interrupting the application thread responsive to receiving notification of an expired timer from the thread monitor.

12. A computer program product, in a computer readable medium, for monitoring threads, the computer program product comprising:
instructions for receiving, from an application thread, notification to start a timer;
instructions for associating the timer with the application thread;
instructions for taking an action responsive to expiration of the timer.

13. The computer program product of claim 12, wherein the action includes interrupting the application thread.

14. The computer program product of claim 12, wherein the action includes notifying a user that a locked condition exists for the application thread.

15. The computer program product of claim 12, further comprising:
instructions for removing the timer responsive to receiving, from the application thread, notification to remove the timer.

16. An apparatus, in a data processing system, for managing an application thread, the apparatus comprising:
a virtual machine;
an application thread running in the virtual machine;
a thread monitor running in the virtual machine; and
a byte code insertion tool, wherein the byte code insertion tool analyzes a portion of code bound to the application thread to identify candidate code that is a candidate to result in a locked condition and inserts first instructions to start a timer and second instructions to remove the timer around the candidate code;
wherein the virtual machine executes the first instructions to notify a thread monitor to start the timer and wherein the virtual machine executes the second instructions to notify the thread monitor to remove the timer if the candidate code completes execution without locking.

17. The apparatus of claim 16, wherein the portion of code is an application class, wherein the first instructions start the timer when the thread begins execution, and wherein the second instructions remove the timer when the thread completes execution.

18. The apparatus of claim 16, wherein the thread monitor receives notification to start a timer from the application thread, associates the timer with the application thread, and takes an action responsive to expiration of the timer.

19. The apparatus of claim 18, wherein the action includes interrupting the application thread.

20. The apparatus of claim 18, wherein the action includes notifying a user that a locked condition exists for the application thread.

21. The apparatus of claim 18, wherein the thread monitor removes the timer responsive to receiving, from the application thread, notification to remove the timer.
